(19) United States
(12) Patent Application Publication
(10) Pub. No.: US 2010/0015576 A1
(43) Pub. Date: Jan. 21, 2010

(54) METHOD AND APPARATUS FOR DIAGNOSTIC AND TREATMENT USING HARD TISSUE OR MATERIAL MICROPERFORATION

(75) Inventors: GREGORY B. ALTSHULER, Lincoln, MA (US); ANDREY V. BELIKOV, St. Petersburg (RU); FELIX I. FELDCHTEIN, Framingham, MA (US); VALERY V. TUCHIN, Saratov (RU); ALEXANDER G. VYBORNOV, Quincy, MA (US)

Correspondence Address: HOUSTON ELISEEVA, 4 MILITIA DRIVE, SUITE 4, LEXINGTON, MA, 02421, US

(73) Assignee: RejuveDent LLC, Quincy, MA (US)

(21) Appl. No.: 12/503,990

(22) Filed: Jul. 16, 2009

Related U.S. Application Data
(63) Continuation of application No. PCT/US2008/051241, filed on Jan. 16, 2008.
(60) Provisional application No. 60/885,009, filed on Jan. 16, 2007.

(51) Int. Cl. A61C 5/08; A61C 19/00

(52) U.S. Cl. 433/218; 607/88; 433/226

(57) ABSTRACT

A method of modifying or treating biological tissue by microperforating hard tissue is disclosed. The method comprises identifying a target area associated with the hard tissue, using a laser beam to perforate at least one incision in the hard tissue, wherein at least one incision has a diameter from a range of 0.001 mm to 0.5 mm and an aspect ratio from a range of 1 to 100 times, introducing a treatment substance into the incision, and causing the treatment substance to interact with the target area. Also a device for microperforating hard biological tissue is disclosed, comprising a laser pump system and a laser head coupled to the laser pump system for generating a pulsed laser having ranges of wavelengths, a pulse duration, pulse energy from a selected range, a beam divergence factor less than 5, a repetition rate higher than 50 Hz; and a beam delivery system comprised of a focusing system for creating a beam having a diameter from a range of 0.001 mm to 0.5 mm.

### CROSS REFERENCE TO RELATED APPLICATION

This application claims priority to an earlier filed US provisional patent application number 60/885,009, filed on Jan. 16, 2007, which is incorporated herein by reference in its entirety.

### FIELD OF THE INVENTION

The invention relates to the minimally invasive diagnostic procedures and treatment of hard biotissues or soft biotissues obscured by hard tissue or hard material. More particularly, the invention relates to the method and apparatus for perforating small diameter incisions in the hard tissue or material to gain minimally invasive access to the biotissue for diagnosis or treatment.

### BACKGROUND OF THE INVENTION

Traditionally, mechanical drilling or sawing is performed to gain access into or through hard tissues, such as dental enamel, dentin or bone. This access may be needed for drug delivery, visualization and diagnostics, dental whitening, to name a few examples.

In the field of dentistry, several methods of gaining access through enamel and dentin are known in the art, including mechanical drilling, laser drilling, air abrasion etc. However, the drilling capabilities of the known techniques and devices are limited to a relatively large diameter (>0.5 mm). This is appropriate when tissue removal is required for caries treatment or for restoration, but not desirable in other instances, when the orifice or incision is only needed to gain access to the tissue or for the delivery of drugs or other compounds. In such circumstances, therefore, tissue removal is an undesirable side effect.

On the other hand, lasers are well known in the art as devices capable of making very small incisions in hard materials, including holes with very high aspect ratios (an aspect ration is a depth to diameter ratio) up to several hundreds or even thousands in special circumstances. Such devices are broadly used in laser machining. However laser heads of the industrial lasers are typically bulky and impractical for use in clinical applications.

The known lasers capable of ablating hard tissue are intended for hard tissue removal, rather than for drilling small incisions or holes. Such lasers have a relatively large beam diameter (0.4 mm to 1 mm) to increase productivity of the tissue removal.

Delivery of a therapeutic or cosmetic compound in or through hard tissue is limited due low permeability of hard tissue. For example, currently known dental bleaching techniques are mostly based on introducing a powerful oxidant, like hydrogen peroxide, into the hard dental tissue. The peroxide oxidizes staining agents, which are mostly organic, resulting in less colored stains than initial staining. Currently bleaching agents are delivered to the dentine by diffusion through enamel. Due to the low permeability of the enamel, high concentrations of bleaching agent are used, increasing the risk of gum damage and hypersensitivity.

### SUMMARY OF THE INVENTION

It is, therefore, an object of the present invention to provide a method and device for a minimally invasive surgical treatment of hard and soft tissue by providing ultra small incisions for delivering various substances into or through the hard tissue. These substances could be used for therapeutical or cosmetic purposes, such as dental whitening, or for diagnostic purposes, such as imaging contrast enhancement.

It is another object of the present invention to control diffusion in the hard tissue of a substance delivered into the incision. It is yet another object of the invention to provide a method and device for reliable and minimally invasive fastening of a prosthesis onto the hard tissue or hard material.

The present invention is a method of modifying or treating biological tissue by microperforating hard tissue. The method comprises identifying a target area associated with the hard tissue, using a laser beam to perforate at least one incision in the hard tissue, wherein at least one incision has a diameter from a range of 0.001 mm to 0.5 mm and an aspect ratio from a range of 1 to 100 times, introducing a treatment substance into the incision, and causing the treatment substance to interact with the target area.

The method is further characterized by the laser beam that has a wavelength selected from a range of 190 nm to 350 nm, or from a range of 2500 nm to3000 nm, or from a range of 9000 nm to 11000 nm, a pulse duration selected from a range of 1 ps to 10 ms and an energy density selected from a range of 0.01 J/cm² to 500 J/cm². The hard tissue can be dental enamel, dentin, dental cement, or bone. The treatment substance is, for example, a dental whitening composition and can comprise sodium perborate, hydrogen peroxide, or carbamide peroxide. The method can further comprise the steps of causing the treatment substance to interact with the target area and controlling diffusion of the treatment substance into the hard tissue. Controlling the diffusion of the treatment substance is done by electrophoresis, magnetophoresis, phonophoresis and thermo-stimulated diffusion. It is also contemplated that the treatment substance can be encapsulated.

The present invention is also a method of microperforating hard biological tissue comprising identifying a target area associated with the hard biological material, using a laser beam to perforate at least one incision in the hard biological tissue, wherein at least one incision has a diameter from a range of 0.001 mm to 0.5 mm, a length from a range of 100 μm to 10000 μm and an aspect ratio from a range of 1 to 100 times. The treatment substance is used for treating caries prevention, pulp therapy, apical therapy, pain management, tooth regeneration, periodontal therapy, or endodontic therapy. The treatment substance can be activated by light. The treatment substance can also be a photodynamic therapy agent, medication and such biological matter as stem cells. The referenced method can further comprise a step of sealing at least one incision after introducing the treatment substance. The treatment substance can be also a biologically inert cosmetic substance. It is contemplated that the treatment compound is selected from the group consisting of TiO₂, Al₂O₃, ZrO₂, SiO₂ and mixtures thereof. A further step of cooling the hard tissue with a fluid during perforation can be performed. The referenced method can further comprise a step of sealing at least one incision after introducing the treatment substance.

The present invention is also a method of mounting a prosthesis on hard tissue comprising perforating at least one incision having a diameter from a range of 0.001 mm to 0.5 mm, introducing at least one mounting pin into at least one incision and fastening at least one mounting pin in the incision, drilling at least one matching incision in the prosthesis or having at least one matching incision be made in advance, and mounting the prosthesis on at least one mounting pin pins and fastening the prosthesis to the hard tissue. The perforating at least one incision can be done by a laser. The laser has a wavelength selected from a range of 190 nm to 350 nm, or from a range of 2500 nm to3000 nm, or from a range of 9000 nm to 11000 nm, a pulse duration selected from a range of 1 ps to 10 ms and an energy density selected from a range of 0.01 J/cm² to 500 J/cm². The referenced prosthesis can be a dental veneer, dental crown, inlay, onlay, dental filling, and wherein the hard tissue is dental enamel or dentin.

The present invention is also a device for microperforating hard biological tissue, comprising a laser pump system and a laser head coupled to the laser pump system for generating a pulsed laser having a wavelength selected from a range of 190 nm to 350 nm, or from a range of 2500 nm to 3000 nm, or from a range of 9000 nm to 11000 nm, a pulse duration from a range of 1 ps to 10 ms, a pulse energy less that 100 ml, a beam divergence factor of less that 5, and a repetition rate higher than 50 Hz; and a beam delivery system comprised of a focusing system for creating a beam having a diameter from a range of 0.001 mm to 0.5 mm and an energy density from a range from 0.01 J/cm² to 500 J/cm² on a surface of the hard tissue. The device further comprises a scanning mechanism for guiding the beam across the hard tissue.

The referenced laser is a diode laser pumped solid state laser, a diode laser pumped fiber laser, or a diode laser, or a flash lamp pumped solid state laser. The device further comprises a handpiece for positioning the beam delivery system against the surface of the hard tissue. The operation of the device can be initiated and stopped by an operator. Or, the operation of the laser can be initiated automatically when the handpiece gets in contact with the hard tissue. Also, the operation of the laser can be initiated by an operator and stopped automatically when a predetermined exposure is reached. In the referenced device the laser head can be housed in the handpiece, or the laser head and the laser pump system can be housed in the handpiece. The device can be battery operated.

### BRIEF DESCRIPTION OF THE DRAWINGS

FIG. 1a is a photo of incisions with a high aspect ratio perforated by a laser in the hard tissue;

FIG. 1b is photo of incisions perforated by a laser in the hard biological tissue.

FIG. 2a is a graph showing a depth of a laser incision vs. a number of laser pulses;

FIG. 2b is a graph showing an aspect ratio of a laser-made incision vs. a number of laser pulses;

FIG. 3 illustrates the pulse sequence and modulation of pulse amplitude or repetition rate;

FIG. 4a is a schematic representation of a general concept of laser microperforation;

FIG. 4b is a schematic representation of an exemplary embodiment of a laser system for hard tissue microperforation;

FIG. 5 is a schematic representation of the mechanical means for fixating the laser beam at the incision site on the tooth;

FIG. 6 is a schematic representation of the increased diffusion speed in dentin by a multi incision pump;

FIG. 7 is a schematic representation of a location of incisions for injecting compounds into dentine;

FIG. 8 is a schematic representation of a prosthesis mounted with pins fastened into incisions;

FIG. 9 is a schematic representation of a microperforated incision used for a diagnostic purpose.

### DETAILED DESCRIPTION OF THE INVENTION

According to the invention, one or more micro-incisions are first drilled in hard tissue, including, but not limited to, dental enamel, cementum, dentine, bone, or oral soft tissues, including but not limited to, oral mucosa, muscle, glands, tongue, pulp, frenum, palate, uvula, and tonsil. The microperforations have a cylinder-like or cone-like shape and are characterized by a certain aspect ratio (AR). The aspect ration can be defined as the ratio of a length of a cylinder-like structure to its diameter. For the referenced microperforations the AR is in the range from 1 to 100, preferably from 5 to 30. For the incisions themselves, the diameter can vary in the range from 1 to 500 μm and the length can very in the range from 100 to 10000 μm. These microincisions can be used for a variety of dental and oral procedures, such as, for example, teeth whitening, delivering therapeutic compounds through the incision to the treatment target, using this incision for dental and oral diagnostic, restoration, orthodontics and prosthodontics.

### Preparation of an Incision with a High Aspect Ratio

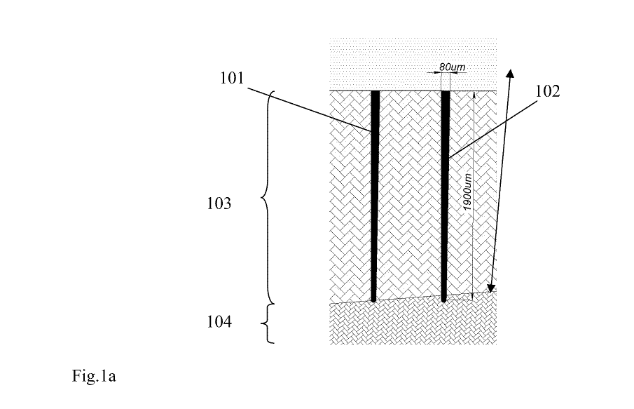

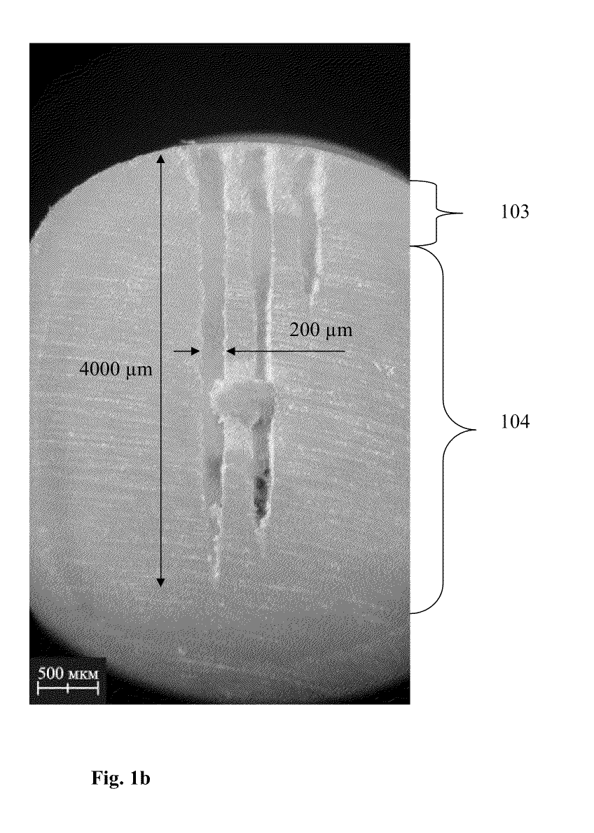

The present invention is based on a discovery that it is possible to use a laser to make tiny holes or incisions with very high aspect ratio in hard tissues. FIG. 1a shows a cross section of a tooth with such holes 101 and 102. The holes were perforated by an Er:YAG laser radiation with the following parameters: a sequence of 30 pulses, energy per pulse E=1.7 mJ, pulsewidth τ=1.4 μs FWHM, wavelength λ=2.94 μm, spatial structure TEM₀₀. After drilling the holes were stained for better picture contrast. The achieved depth of the holes in enamel 103 and dentine 104 is about 1900 μm with the diameter of about 80 μm and the aspect ratio of about 23. Another example of a cross section of a tooth with the drilled holes is shown in FIG. 1b, which shows the depth of incision in a molar perpendicular to the tooth axis being about 4000 μm with the diameter of about 200 μm.

The depth, diameter and the aspect ratio of the holes or incisions can be controlled by the parameters of a laser. For example, the depth of an incision and its aspect ratio can be controlled by the number of pulses in a sequence which is applied to the same point of the target area on the surface of the tissue.

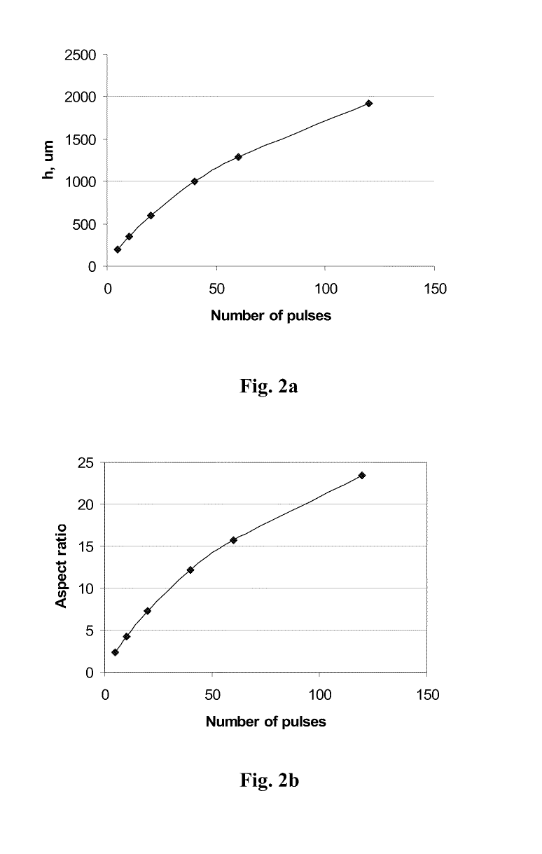

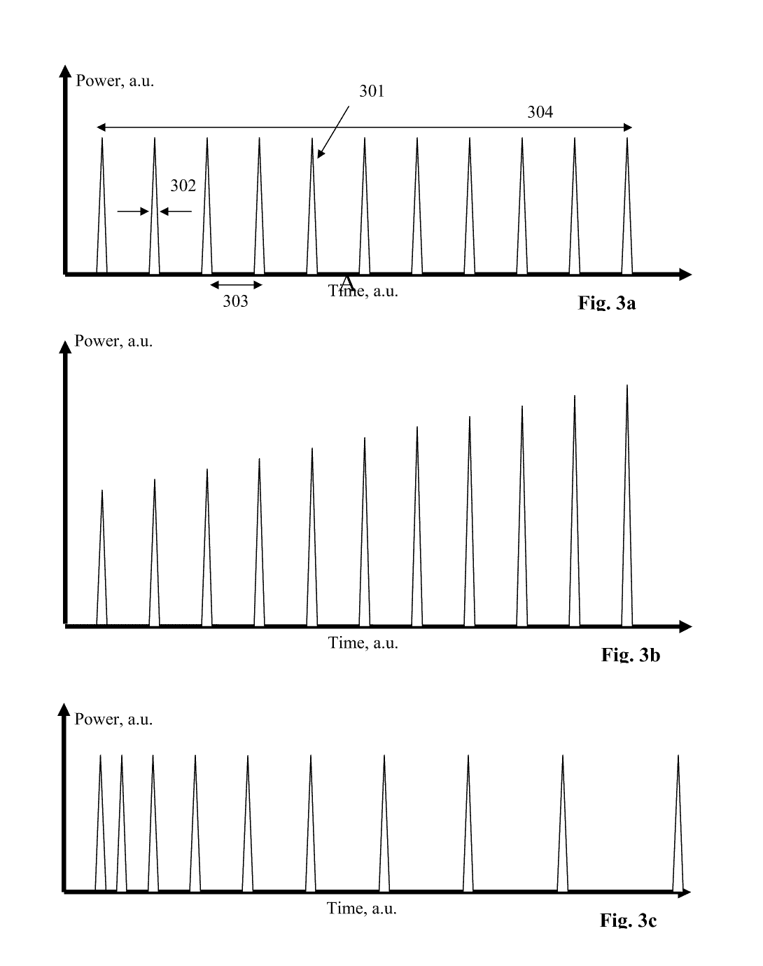

FIG. 2 shows the dependency for laser parameters described above. The depth vs the number of pulses dependency is reproducible for the same type of tissue and can be used for a clinical setting of the laser parameters. The perforated holes or incisions can be visualized and measured in vivo using existing imaging modalities, like X-rays or optical coherence tomography. Similar micro incisions in the dental hard tissue and dental material can be made with a wide range of laser parameters and different type of lasers. A laser having an ultra short pulse in the range of 1 to 1000 fs can be used for precise hard tissue perforation. The wavelength of this laser can be in the range of 100 to 20000 nm. Due to the multiphoton absorption of such pulses with very high intensities, practically all the wavelengths in this range are useful. A fluence on the tissue surface is in the range of 0.0001 to 0.1 J/cm². For a laser with a pulse width longer than 1 ps, a linear absorption is used and, therefore, the laser has a wavelength that is highly absorbed by the hard tissue.

The wavelength of the long pulse laser is preferably in the range of 100 to 350 nm or 1850 to 11000 nm. The fluence for radiation with a pulsewidth in the range 1 ps to 10 ms is preferably in the range of 0.01 to 500 J/cm² for the ablation of the treated tissue or material to be possible. In the preferred embodiment, the pulsewidth range is from about 0.1 μs to about 2000 μs, and the wavelength range is from about 100 nm to about 350 nm, or from about 2690 nm to about 3000 nm, or from about 9300 nm to about 10600 nm. The fluence in each microbeam is in the range from about 1 J/cm² to about 100 J/cm². The diameter of the microbeam for microperforation is in the range from 0.5 to 500 μm. Preferably, the diameter is within the range from 5 to 300 μm.

For microperforation a sequence of pulses should be used. The sequence consists of 1 to 2000 pulses, preferably 10 to 200 pulses. The energy and the pulsewidth of all pulses in the sequence could be the same, or could be modulated by a certain algorithm. For example, the energy of pulses can be increased from the beginning to the end of the sequence (FIG. 3). All pulses from the sequence are applied in a small area on the tissue surface, the size of the area being smaller or about the same as the diameter of the incision. For this reason the duration of the sequence is shorter than the time which a dentist can keep the laser beam aligned to the treatment point on the tissue surface. This time, preferably, is shorter than several seconds, and, preferably shorter than 0.5 sec. In another embodiment, a microbeam is fixed to the treatment point on the tissue surface with an alignment fixture, which is keeping the handpiece and the microbeam in place.

Different types of lasers with described parameters can be used to practice this invention, including, but not limited to, a diode laser, a diode laser pumped solid state laser, a diode laser pumped fiber laser, a flash lamp pumped solid state laser, the same laser with a non linear converter, an eximer laser, a CO₂ laser. A solid state or a fiber laser group laser doped by Er, Ho, Nd, Tm, Yb, Cr, Ti, Pr ions can be used. To be able to microperforate small incisions, the diameter of a microbeam on the target should be very small, therefore, requiring a low divergence of the laser beam, preferably close to the diffraction limit for a given wavelength. The beam divergence is characterized by the M² factor, which is the ratio of the beam divergence to the divergence of a Gaussian beam of the same diameter. The M² factor of a laser of the present invention is in the range of 1 to 10, preferably 1 to 5 and, most preferably, 1 to 2. Such low divergence can be achieved in a single mode fiber laser, a VCSEL diode laser, or a single mode diode pumped solid state laser. The diameter of an incision is determined by the size of the microbeam. The microbeam diameter of a laser with the M² factor of about 1 can be as low as about one wavelength.

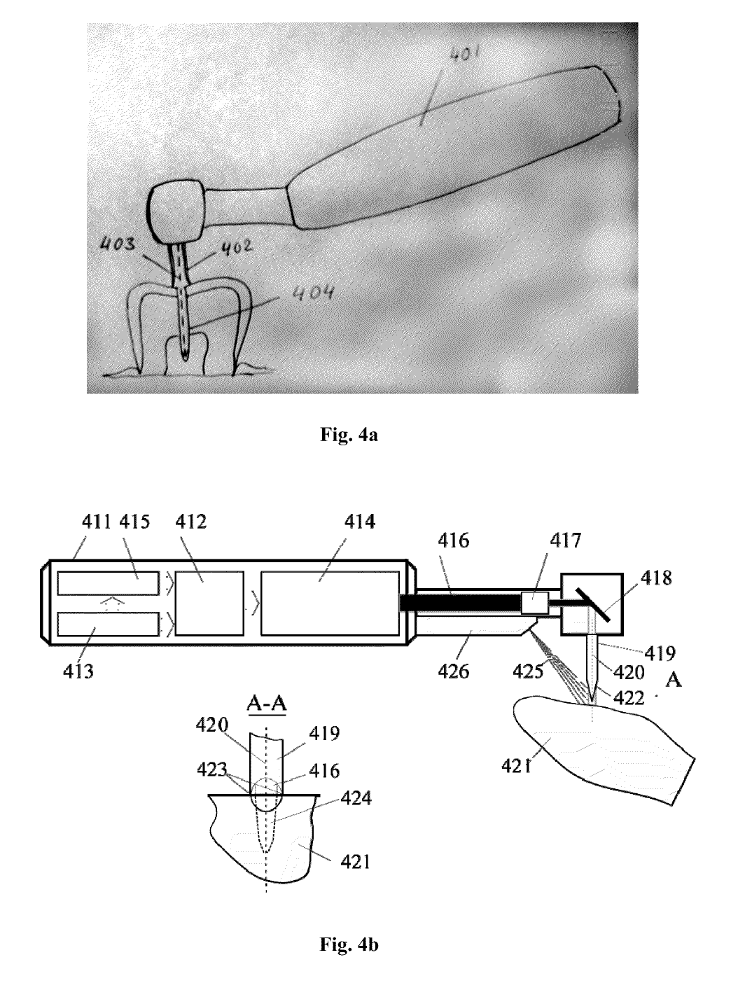

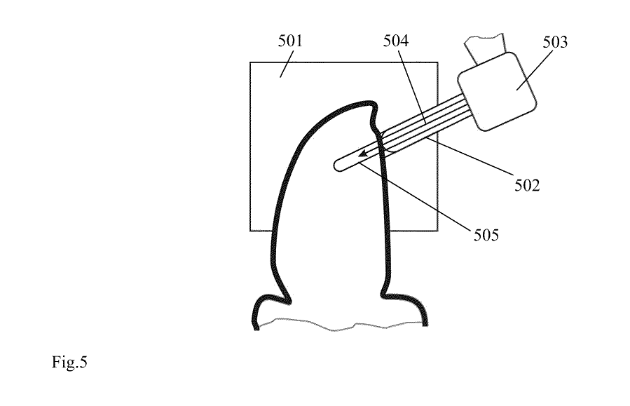

FIG. 4a shows a laser perforator 401 for a tooth. Laser perforator 401 is connected to the treatment area of a tooth or bone through tip 402, providing for a fixed position of an output beam 403 to the incision 404 in the tissue during perforation. The tip 402 can be a dental explorer, tube, fiber, or a hollow fiber. In another embodiment of the invention, the tip 402 can be a part of an optical system, such as rangefinder, for assessment of the distance between the perforator and the surface of the tissue.

FIG. 4b shows a schematic diagram of the laser microperforator for making incisions in the hard or soft tissue or dental material. The laser is located in the handpiece 411 and contains a laser driver 412 and a control unit 413, a laser head 414 and a cooling system 415. The laser radiation 416 from the head 414 is focused by an optical system 417 and reflected by a mirror 418 to the treatment tissue or material and propagates along the tip 419. More specifically, the laser radiation propagates along an axis 420 and impinges on the surface 421 of the tissue or the material.

In another embodiment of the invention, the laser energy can be delivered into the handpiece through an optical waveguide. Focusing system 417 can contain a diffraction or holographic optical element with a long focal depth to provide deeper perforation. The tip 419 has a bevel 422 and two or three sharp thrusts 423 symmetrically oriented around the axis 420. Since the laser radiation propagates along the axis 420, the perforated incision 424 will be aligned with the axis 420. The laser drilling can be combined with liquid or mist cooling, as well as with the removal of the ablation debris by a gas jet. The tissue cooling system 426 delivers the cooling liquid or mist via the nozzle 425 into the space between the tissue surface 421 and the bevel 422 of the tip 419.

While laser drilling of the incisions with high aspect rations can occur without any focus adjustment (partially because of the linear and nonlinear self-canalization effects), the drilling can be further enhanced by the appropriate focus adjustment during the drilling sequence as the incision gets deeper. In one embodiment, the focal position can be moved along the depth of the incision, so that the light intensity will be maximized at the bottom of the incision where most of the tissue or material ablation occurs. In another embodiment, the focal position can be adjusted both in depth and in radial direction, creating a spiral path, which is known to enhance laser drilling. Optical element 417 and mirror 418 can provide such a beam scanning function by preprogrammed motions using micromotors, for example, a piezo motor, or high pressure air. The total energy required for several perforations can be in the range of 10 mJ to 10 J. Using a high efficiency laser, such as diode laser, a diode laser pumped fiber laser or a solid state laser, these energies can be generated by a handheld battery operated device. This device can be recharged between treatments. Tip 419 can deteriorate during the ablation process and may need cleaning between treatments, unless it is a single use disposable. For a free-running Er: doped laser with a pulse duration of several p s to several ms, it is preferable to have the laser operating in a relatively small pulse energy range from 1 to 50 mJ, so that the fluence in the focused beam with the diameter from 0.03 to 0.3 mm will be sufficient for effectively ablating hard tissue, but yet not inducing the optical breakdown of the bulk material of the tip or its surface. To prevent the misalignment of the tip from motion or displacement, drilling should be performed in a short time, therefore, the laser should have a high repetition rate, preferably from 50 to 2000 Hz. The laser head with such parameters can be cost and energy effective and compact enough to fit into a handpiece. The ability to place the laser head in the handpiece eliminates the need for a radiation delivery system, which is normally made as an articulated arm or a fiber. The articulated arm is bulk, cumbersome, expensive, it is difficult to align and handle. The infrared fiber is also expensive, prone to the optical damage and, more importantly, substantially increases the light divergence, making it difficult to focus the laser into a small beam to drill small incisions. Therefore, the possibility to place a compact laser head into a handpiece creates a great advantage in producing a low divergence beam, well suitable for focusing into a small area and performing effective microperforations. Additionally, the laser pump system could be housed in the handpiece or in a small unit located in the proximity to the handpiece. The entire laser could be made battery operated.

In another embodiment of the invention, the system for the tooth microperforation consists of a computer, a digital video camera, a display, a computer controlled laser with power supply, a marking device and a closed loop control system. The marking device creates a visible mark on the tooth surface at the site to be perforated, and the control system maintains the laser beam position at the marked site, compensating small movements of the operator hand and of the patient.

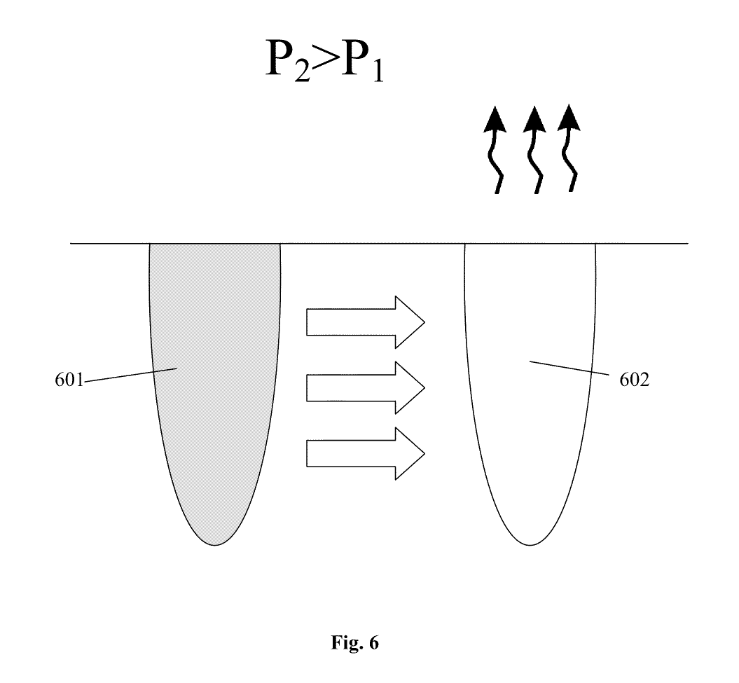

During the process of laser drilling the beam delivery system can be fixed relative to the treatment site, as shown on FIG. 5. A fixture 501 is applied to the treatment zone of the tooth. Fixture 501 can be made of plastic having a shape matching the tooth, or it can be prepared similarly to a temporary crown or bridge. The hole 502 or holes with the diameter close to the diameter of the tip 506 of laser handpiece 503 can be prepared to fix the position of the incision 504. The tip 503 can be an optical refraction waveguide, such as an optical fiber, or a hollow waveguide, such as a tube with an inner diameter close to the diameter of microbeam 504, creating the incision 505.

The target area of the site to be microperforated can be marked in advance and then a video camera or reflectivity sensor combined with the handpiece can be used to initiate the laser operation when the tip is pointing to the target. The handpiece can be operated automatically (software driven), or manually, for example, by a doctor performing the procedure. In one embodiment, the laser operation is initiated by an operator and stopped automatically when a predetermined exposure is reached. The number of pulses required to perforate a definite depth can be calibrated in advance (in accordance with the graph on FIG. 2, for example). The temporal structure, shown on FIG. 3a, is sequence of micropulses 301, with pulsewidth τ (302), period T (303) and total length N-T (304), where N is the number of pulses in the sequence, and equal energy per pulse E, where i is the number of pulses in the sequence. FIG. 3b shows the pulse sequence with energy of micropulse Eᵢ increasing from the start to the end. For example Eᵢ=E₀ +ΔE-i or Eᵢ=E₀+ΔE-exp(ψi), where ΔE and ψ are the parameters of energy increasing in the sequence. In this embodiment, increasing the energy over the train is done in order to compensate for the attenuation of the microbeam due to the increased penetration in the tissue or the material.

FIG. 3c shows another embodiment of the invention, when the interval between micro pulses T changes during the sequence. For example, Tᵢ=T₀+ΔT-i or Tᵢ=T₀+ΔT-exp(ω-i), where ΔT and ω are the parameters of interval increasing in the sequence. Due to an increased interval between micropulses in the train, ablated material is better removed between the pulses to provide for more efficient ablation for every next pulse. Additionally, better cooling of deep holes can be achieved between pulses in that embodiment. In yet another embodiment, laser operation is initiated automatically when the handpiece touches the hard tissue or detects the previously marked spot.

Incisions with the described geometry can be prepared by using other energy sources. Such source can be the high intensity focused ultrasound, an acoustic wave generated by a laser, the flow of microparticles accelerated by a high pressure gas, liquid or light radiation.

For more precise and controlled perforation of an incision different means of real-time feedback can be used, including optical, optoacoustic, optical fluorescence, optical reflection (integrated or depth-resolved using optical low coherence reflectometry or optical coherence tomography).

### Diffusion of a Compound in Hard Tissue

Another application of the method and device of the present invention is the possibility of delivering various treatment substances or compounds into the hard tissue, in particular, to the dentin. An average composition of the human dentine is the following: hydroxyapatite (72 wt.%), organic material (18 wt.%), and water (10 wt.%). The peritubular dentine is a continuous mineral matrix (hydroxyapatite, 90-95%) with embedded collagen fibers (5%) and water. The intertubular dentin is a matrix of type I collagen (20%) reinforced with hydroxyapatite nanocrystals (70%), and 10% of water. Tubules have an inner diameter in the range from 0.6 to 1.0 mm depending on the portion of the tooth. Their density also substantially depends on the location of the tooth. The mean tubule density vary from 9 to 24 per 0.1 mm, i.e., from 8100 to 57,600 tubules per mm². The extreme range in the density of tubules is from 7 to 30 per 0.1 mm, i.e., from 4900 to 90,000 tubules per mm².

Tubules have different types of branches that could be identified on the basis of size, direction, and location. The major branches are often characterized by their dichotomous or trichotomous divisions, have an inner diameter of 0.5 to 1 mm and the direction generally similar to that of the main dentinal tubule. They are located mostly near the dentine-enamel junction and the cementum-dentine junction. The term “fine branches” is used to describe thin branches extending peripherally at an angle approximately 45° to the wall of the tubules. They occur at 3 to 5-mm intervals and penetrate the intertubular dentine, often extending up to 50 mm across two to five tubules. In the demineralized dentine the diameters are from 300 to 700 nm at the exit from the dentinal tubule. The demineralized dentin also has small pores in the intertubular dentine in all parts of the dentine. The diameters of these pores range from 25 to 200 nm, with the majority of the pores being approximately 100 to 150 nm in diameter. In the undermineralized dentine the majority of these pores originated as minute, hollow structured, fine branches that have an inner diameter of 50 to 100 nm, extending at an almost perpendicular angle to the dentinal tubules through the peritubular dentine into the intertubular matrix.

As a simplest dentinal model describing diffusion of a matter through the hard tissue is a layer of material with three different diffusivities along the tubules (water filled cylinders), along peritubular structure (shallow cylinder with more dense material, less penetrative), and within intertubular space. The distribution of human tubules in dentin is consistent with a periodic array of lattice sites randomly displaced by a maximum distance (L) of about 20% of the distance between the lattice sites (L₀). For the density of these sites to be equal to the tubule density (N), the distance L₀ should be equal to the average intertubular distance:

L₀=1/\sqrt{N}. (1)

For such three component one-layer model, the permeation coefficient for an agent diffusion may be presented in the form assuming that the permeation coefficient is the summation of permeation coefficients Pᵢ for different pathways: through tubules (tub), intertubular (itub) and peritubular (ptub) spaces, which are weighted by the filling factors of the corresponding pathways

$$\begin{matrix}{P}_{D} = {f}_{tub} {P}_{tub} + {f}_{itub} {P}_{itub} + {f}_{ptub} {P}_{ptub} , \\ where & ( 2 ) \\ {f}_{tub} + {f}_{itub} + {f}_{ptub} = 1 , & ( 3 ) \\ {P}_{j} = \frac{{D}_{j}}{{h}_{D}} , & ( 4 ) \\ {f}_{tub} = \frac{π {d}_{tub}^{2}}{4 S} {N}_{tub} , & ( 5 ) \\ {f}_{tub} = \frac{π ( {d}_{ptub}^{2} - {d}_{tub}^{2} )}{4 S} {N}_{tub} , & ( 6 ) \\ {f}_{itub} = 1 - ( {f}_{tub} + {f}_{ptub} ) , & ( 7 )\end{matrix}$$

j=tub, itub, and ptub: Dⱼ is the diffusion coefficient of an agent in the corresponding part of hard tissue layer; h_{D} is the thickness of dentinal slab that is cut along tubule direction; d_{tub} is the mean diameter of the tubules; d_{ptub} is the mean value of the maximal (external) diameter of the peritibular zone that is a ring with the small (internal) diameter equal to d_{tub}; N_{tub} is the number of tubules, which is equal to the number of peritubular zones, within a dentinal sample surface area S, i.e., N_{tub}/S is the mean density of the tubules.

The agent's permeability through the tooth as a whole could be evaluated using the above-described three component model for the dentin and dentin-enamel boundary, and one- or two-component model for diffusion through the enamel (accounting for the prismatic structure of the enamel). In that case the total permeability coefficient, P_{T}, for an agent diffusing through the dentin, the dentin-enamel junction and enamel is defined as

$$\frac{1}{{P}_{T}} = \frac{1}{{P}_{D}} + \frac{1}{{P}_{DE}} + \frac{1}{{P}_{E}} , \qquad ( 8 )$$

where P_{D}, P_{DE}, and P_{E} are the permeability coefficients for the agent diffusing through the dentin, dentin-enamel junction, and enamel, respectively. P_{D} is defined by Eq. 2, P_{DE} is defined by the equation similar to Eq. 2, and P_{E} is defined also by Eq. 2 written for a one- or two-component system with the corresponding structure elements and values of parameters.

Using equations (2)-(8) and the fact that the tubules have their inner diameter in the range from 0.6 to 1.0 μm and the mean tubule density varies from 9 to 24 per 0.1 mm, i.e., from 8100 to 57,600 tubules per mm², we calculated the volume fractions of the tubules (tub), intertubular (itub) and peritubular (ptub) spaces, and the permeation coefficients. We used the following values for the diffusion coefficients of an agent in the corresponding part of a hard tissue layer: for water diffusion in intertubular dentine 1.74×10⁻⁶ cm²/sec; for tubular 1.74×10⁻⁵ cm²/sec, and for peritubular 1.74×10⁻⁷ cm²/sec; for H₂O₂ diffusion in intertubular dentine 3.6×10⁻⁷ cm²/sec; for tubular 3.6×10⁻⁶ cm²/sec, and for peritubular 3.6×10⁻⁸ cm²/sec. The thickness h_{D} of the dentinal slab along the tubules that is cut perpendicular to the direction of the tubule was taken to be 1 mm. Using Eq. 8, we calculated the total tooth layer permeability for the above calculated values of dentinal permeability P_{D}.

A similar model could be used to describe diffusivity not only via natural channels (tubules) but via artificial ones drilled by laser. In order to prove the concept, it is important that increases of the channels diameter and of their density leads to an increase of peroxide and water diffusivity (permeability). This is also valid for any drug delivery through perforated hard tooth tissues.

### Diffusion Control by a Multi-incisions Pump

To facilitate the diffusion of an active agent within the hard tissue, or to influence its preferred direction, it is possible to create a pressure difference between tissue areas. We call this technique a multi incisions pump. The principle of its operation is illustrated on FIG. 6. An active ingredient (like peroxide, medication etc) is introduced into one group of incisions 601 and a volatile matter is introduced into another group of incisions 602. Evaporation of the volatile matter creates an area of reduced pressure around the second group of incisions, and the pressure gradient facilitates diffusion of the active ingredient towards these incisions. Incisions 602 can be filled by a water-absorbing material, for example sol gel. In another embodiment the active ingredient can be injected into the incisions 601 through a micro needle and mechanisms of high pressure from a syringe, or other external sources of high pressure. At the same time another micro needle can be applied in incision 602 with negative pressure.

Another way of diffusion control is to initially place a predetermined amount of the substance into a specific area of the tooth, such as dentinoenamel junction, predentin, Thomes granular layer, periodontal pocket, bone, or mucosa.

Yet another way of diffusion control is to apply some external energy to the active ingredient and the hard tissue matrix, such as external pressure, heat, light, an electrical field or current, a magnetic field, ultrasound, etc. To accelerate the diffusion process, the external energy should increase permeability of the active ingredient or increase matrix permeability. Also, some substances, such as DMSO (dimethyl sulfoxide) or NaOH are known to increase matrix permeability and serve as carriers of the active ingredients. They can be used within the hard tissues.

For some applications, the diffusion should be spatially limited. For example, for dental whitening it is important to prevent peroxide or other oxidants from penetrating into the dental roots or pulp, as it can induce inflammation, pain, and root resorption. The pulp protection can be accomplished by selecting active ingredients which are unable to penetrate the predentin layer. The root cementum can be protected by selecting active ingredients which are unable to penetrate the Thomes granular layer.

For some other applications, the pace of diffusion should be slowed down, for example for extended-release drug delivery. For this purpose the active ingredient can be encapsulated into a low permeability shell and the entire capsule can be inserted into the incision and left there for slow release.

For other applications it is desirable to facilitate the substance accumulation at the dentinoenamel junction (DEJ). This can be accomplished by perforating the laser incisions to end at the DEJ. Another possibility is to use active ingredients which are selectively absorbed in the interglobular dentin or in the Korff's fibers. Yet another possibility is to use active ingredients unable to penetrate into enamel, after which the ingredients will be pushed out of the dentin by detinal fluid movement, and will therefore accumulate at the DEJ. Yet another possibility is to use particles of a size less than the gap between the collagen fibers or the intratubular dentin, such as fullerene or astrolene particles, titane oxide or zirconium oxide particles. These particles can be surrounded by a chemically inert shell, such as a lipid shell. After letting these particles become substantially distributed in a uniform manner at the DEJ, they can be irradiated by a laser light, thus destroying the lipid shell. After the removal of the chemically inert shell, the particles will start to chemically react with the hard tissue, or to aggregate into macromolecules, thus changing the optical scattering and creating a whitening effect.

Selective delivery of a substance into the apical area can be performed by microperforation with a laser, through the attached gum, and then through the bone into the root apex area. Selective delivery into the periodontal area can be performed by laser microperforation of the free gum into the periodontum, or into the epithelial attachment. Alternative selective delivery into the periodontal area can be performed by laser microperforation of the attached gum and bone.

After the introduction of the active ingredient, the incisions may be left open or closed. In the latter case several techniques can be used. In one embodiment, a filling material is introduced into the incision via a needle, which is extracted as the incision is filled and the filling material is cured chemically or using light. A highly flowable material like Revolution made by Kerr Corporation can be used for that purpose.

In another embodiment a solid rod or tube is placed into the incision, then melted by the application of an external energy source (pressure, heating, light, ultrasound), and then is cured/solidified chemically or optically. The initial solid material can be a solution of frozen water and a filler: dental cementum, light-curing polymer or chemically cured polymer resin. In yet another embodiment a filler can stimulate hydroxyapatite crystal growth (for example a water solution of 8% ethyldiaminetetraacetic acid, 1% calcium titanate, 1% hydroxyapatite, and 0.1% NaF.

### Dental Whitening

The inventors performed theoretical and experimental evaluation of internal dental bleaching by introduction of peroxide or a similar material into the laser microperforated incisions. The measured diffusion rate of the bleaching agent was consistent with other data obtained on internal tooth bleaching, and allows the substantial bleaching effect to be reached several days after the introduction of the bleaching agent into the incision.

### In Vitro Whitening Example.

One freshly extracted lower human incisor was used in the experiment. Immediately after extraction, the tooth was stored in a 0.1% w/w thymol solution at a temperature of +4-6° C. for 3 weeks.

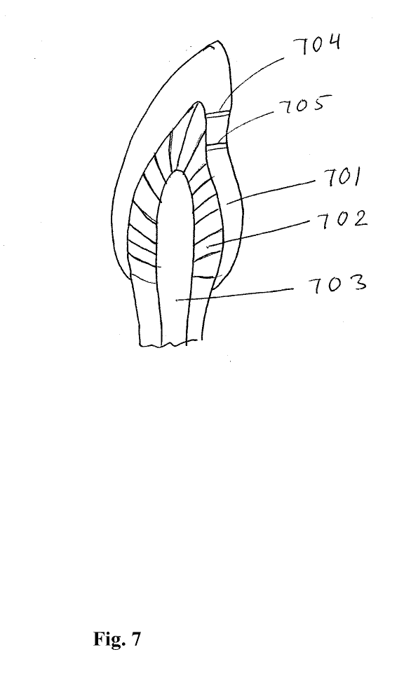

The tooth was then extracted from the thymol solution, cleaned with toothpaste (Colgate Total Whitening) for 2 minutes, washed under distilled water, cleaned with an abrasive powder (medium coarse #3, Kerr Dental) for 30 seconds, and then washed under distilled water again. The color shade of the tooth was 2M₂ as measured on the Vitapan 3-D Master shade guide. Next, several (2-10) micro incisions 704 and 705 were made on the lingual side of the tooth as schematically shown on FIG. 7. Perforation was performed through enamel 701 and dentine 702 above the pulp chamber 703 from the lingual side of a tooth. The distances between the centers of adjacent perforations were in the range of 200-400 μm. The perforations were performed with an Er:YAG laser of the following parameters: wavelength—2.94 μm; pulse width—125 μsec; pulse energy—30 mJ; repetition rate—2 Hz. Each perforation was created with a sequence of 65-100 laser pulses. A sequence of 75 pulses created a crater with a diameter of about 200 μm and a depth of about 2.5 mm. After drilling, a drop of pre-heated hydrogen peroxide—having the following parameters—was placed on the micro-perforations at room temperature: concentration—33%; temperature—65±5° C.; volume—0.25 ml³. After one minute, the remaining hydrogen peroxide was removed from the tooth surface with a paper cloth. The above steps were repeated several times. No peroxide was observed on the tooth surface at the completion of the experiment (it either evaporated or penetrated the tooth surface). The color shade of the tooth in 14 hours—the tooth was completely whitened with color shade 1M₁ vs. the initial color shade 2M₂. Significant brown discoloration of the root surface was completely bleached in 14 hours.

### In Vivo Whitening Example.

The inventors performed limited evaluation of the proposed invention in vivo. Three patients have been enrolled—patient 1—42 y.o. male, patient 2—20 y.o. female and patient 3—22 y.o. female. All patients had teeth to be extracted for orthodontic reasons and these teeth were bleached by the proposed technique involving laser microperforations. Patient 1 had two upper medial incisors processed, and the control was upper right canine. Patients 2 and 3 had the first lower left premolar processed, and first right lower premolar as the control.

The whitening procedure included several stages. After the initial examination, a cleaning had been performed. More specifically, the frontal coronal surface of the processed and control teeth was cleaned by a water suspension of the Kerr Pumice#3 powder for 30 s under room temperature. Then we used a diamond bur to create small incisions 2.5×1.0.×0.2 (length×width×depth) mm on the frontal coronal surface. Then we performed a series of laser microperforations at the bottom of these incisions (4 laser holes for patients 1 and 2, 6 laser holes for patient 3). The laser parameters were: wavelength 2.79 μm, free running regime, repetition rate 5 Hz, pulse energy ˜50 mJ. Each laser hole was perforated by a sequence of 80 (Patient 1) or 60 (Patient 2 and 3) pulses, a water irrigation of 0.2 ml was applied after each 5 pulses. After laser microperforation, the oral mucosa was isolated from the treatment space by a cofferdam, then frontal coronal part was cleaned by 96% alcohol and a piece of a silk thread was inserted in each laser incision (thread diameter 155 μm, length ˜3 mm) to the full depth and the remainder was left flat in the mechanical incision. Then the hydrogen peroxide solution was introduced into the mechanical incision at 37° C. The peroxide solution was refreshed every 5 minutes and the procedure was continued for 105 min (Patient 1), 70 min (Patient 2), and 45 min (Patient 3). The excess peroxide was removed by a syringe or cotton ball without touching the silk thread. Then the incision was rinsed with water, the silk thread was removed, and the incision was filled by with flowable composite “ESPE Ketac Molar easy mix” manufactured by 3M. The whitening effect was measured using standard VITA scale with baseline taken just before the procedure and then immediately after the procedure, at 1 day (except for Patient one at 5 days) and at 7 days after the procedure. For Patient 1 the whitening was one shade in 5 days and one more shade in 7 days. Patients 2 and 3 had two shades (A3 to A1) effect in 1 day, reversing one shade in seven days back to A2. Therefore in all three cases we observed reliable whitening effect. We didn't observe any adverse effects on the oral mucosa. The follow-up histopathology confirmed the vitality of the pulp.

In another embodiment, a compound with fluorescence capability can be delivered into the tooth for tooth whitening and to protect the dentine collagen from photo damage. This compound can absorb short wavelength light and re-emit it with shorter wavelengths. For example, the particle quartz or glass particles doped with Ce and having a size in the range from 1 to 1000 nm. Ce ions are absorbing UV light (λ<390 nm) and re-emitting it in blue range (380-450 nm). Such fluorescence will increase total “reflection” of visible light and correct the reflection spectrum with the increased reflection in blue range, which effectively provides a whitening effect. Another example is Sm doped glass or crystal nano or micro particles.

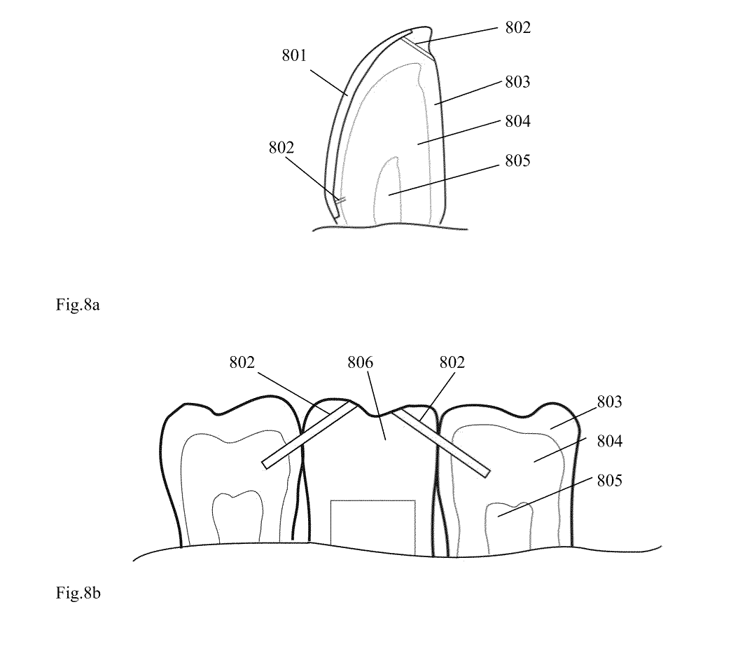

One of the applications of the hard tissue microperforation is to improve prosthesis fastening, using micropins inserted into the incisions. The prosthesis can be a dental veneer, dental crown or just a dental filling. FIG. 8 illustrates two embodiments. In one embodiment (FIG. 8a), several pins 802 are inserted in the incisions made in the dentin 804 or enamel 803. The veneer 801 has matching incisions, where the outstanding parts of the pins 802 are inserted and fastened from both sides. In another embodiment (FIG. 8b), two or more pins 802 are fastening a crown 806 to the neighboring teeth, reducing the mechanical load on the remaining tooth part holding the crown.

### Diagnostic Uses of the Microperforations

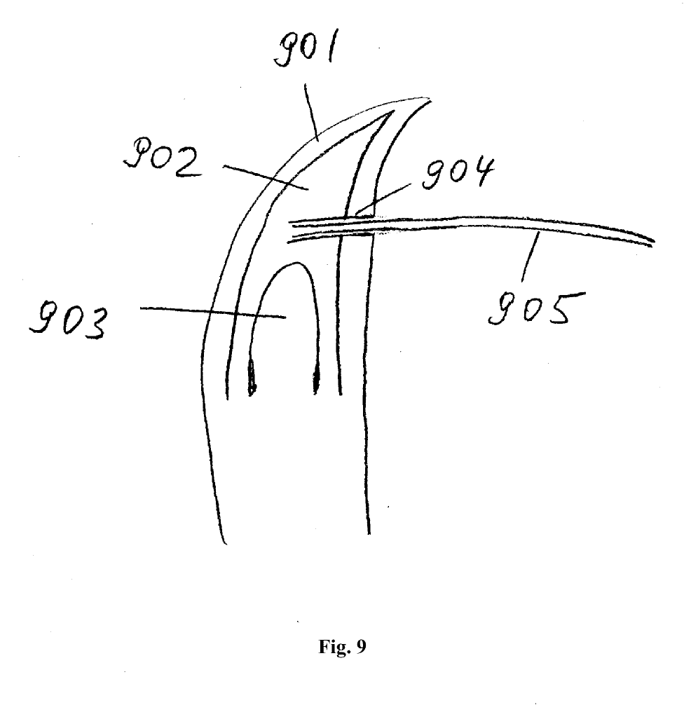

FIG. 9 illustrates some of the possible diagnostic uses of the hard tissue microperforations. It is possible to insert an optical fiber 905 into a small incision 904 through enamel 901 and dentine 902 and use it to visualize the hard tissue or the pulp 903 or another soft tissue behind the incision. A fiber 905 can also be a part of a forward-looking, 2D imaging instrument, such as spectrally encoded confocal microscope, or optical coherence reflectometry, or optical coherence tomography (OCT) system. In another embodiment, a fiber can be a part of side-looking 2D or 3D imaging instrument. A circumference of the incision can be imaged by the fiber rotation, and 3D imaging can be performed by pulling the rotating fiber out of the incision, providing a spiral 3D scan. Accordingly, the bulk of the dentin, as well as pulp chamber and other areas, can be visualized with minimal invasion, for example pulp chamber can be viewed through the dentin. In another embodiment, it is possible to introduce a contrast enhancement agent into the incision, such as X-ray contrast, fluorescent agent, or a refractive index matching agent, reducing optical scattering. In the latter case, the penetration of the OCT imaging could be significantly enhanced, making it possible to visualize even more areas inside the tooth.

### Other Dental Applications

In one embodiment a series of microincisions with the diameter of 10 μm and depth less than 1 mm is perforated on the occlusal surfaces (pits and fissures). The compound is deposited to the surface with increased concentration of Ca, P and F, with removal in 1-2 days. The compound could be a part of the toothpaste and can be deposited regularly.

In another embodiment, a series of microincisions is made in a fissure and then an antiseptic is introduced into these incisions to prevent bacterial growth. In another embodiment, a compound with an antibacterial effect can be injected into the dentine through the incision to prevent the formation of dentinal caries. This compound can contain a photosensitizer, which can be activated by light absorbed by the photosensitizer, to generate singlet oxygen or active radicals with an antibacterial effect.

In one embodiment a laser microperforation is made directly into the pulp chamber, then arsenic or another nerve destructive substance is introduced and the pulp is aspired, then the chamber is disinfected and filled.

In another embodiment the laser microperforation is performed only into the dentin and ends in the vicinity of the pulp chamber, and then a medicine is introduced to treat the pulp.

A laser microperforation is performed through the gum and bone into the root apex. Then some of the incisions are used to drain the area and others to introduce an antiseptic (antibiotic drug, alcohol, formaldehyde etc)

In one embodiment a laser microperforation is performed in the gum or in the area of oral mucosa to anesthetize, and the anesthetic is introduced into the incision(s) under pressure. In another embodiment a series of microincisions is perforated in the gum or oral mucosa and then a plaster with anesthetic is topically applied for 5-10 minutes, so the anesthetic will penetrate quickly through the incisions.

A series of microperforations is performed in the free gum towards dental root cementum and then the medicine is introduced through these incisions to treat periodontal tissues. The medicine can be applied topically via a plaster or using a rinse.

Tooth loss due to periodontal disease, dental caries, trauma, or a variety of genetic disorders continues to affect most adults at some time in their lives. At present, the methods for the creation of artificial teeth (dentogenesis) through tissue engineering, are developed through a few main ways. One them is the so-called direct dentogenesis. The cellular mass consisting of enameloblasts, odontoblasts and low-differentiated epithelial and stromal mesenchymal cells can be made in the form of a suspension. Biodegradable polymers, based on organic acids, (PGA, PGLA) are used. These form a 3D matrix in the shape of a tooth. A cellular culture is placed on a matrix, and this is grafted onto dental alveolus where, under the influence of cellular and tissue microenvironment factors, dentogenesis occurs.

The creation of tissue engineering constructions for dentogenesis de novo is a real modern prospect. The main problem is maintaining blood supply to the artificial tooth after grafting, as the direct dentogenesis technique in clinical practice can cause a number of inconveniences. During a minimum course of 30-35 weeks, improper blood supply may cause problems having to do with the creation of certain conditions within the microenvironment of the developing tooth. It is necessary to note, that the creation of a tooth as body de novo can be counted as a breakthrough in reconstructive dentistry.

One of the promising applications of hard tissue laser drilling is the stimulation of stem cells and their delivery for the provision of reconstructive dentistry. According to the most generally accepted definition, stem cells are a special group of undifferentiated cells possessing two fundamental properties: they are capable of self-maintenance, and differentiation into specialized tissue-forming cells. According to their origin, stem cells are divided into embryonic and somatic ones.

Successful long-term restoration of continuously self-renewing dental tissue depends on the use of extensively self-renewing stem cells. Tissue stem cells form the cellular base for organ homeostasis and repair. Stem cells have the unusual ability to renew themselves over the lifetime of the organ, while producing daughter cells that differentiate into one or multiple lineages.

It is well known and documented that in in vitro tissue engineering, special bioreactors are designed to maintain physiological parameters similar to those found in vivo and enable the application of force to cells. Key elements for tissue culturing are the following: long term culture controlled mechanical environment, physiologically relevant, sterile, and implant dimensions.

Most cells in tissues contact an extracellular matrix on at least one surface. These complex mixtures of interacting proteins provide structural support and biological signals that regulate cell differentiation and may be important for stem cell differentiation.

The concept that laser drilled hard tissue such as dental alveolus can serve as an in vivo natural bioreactor for stem cells activity should be attractive and realistic. Typically in tissue engineering the following parameters are under monitoring and control: cell behavior on the scaffolds, cell proliferation, location, phenotype, and activity, scaffold degradation and matrix production, tissue formation and characterization of growth, and implant behaviour in the patient. Required parameters for efficient tissue engineering, such as porosity, channels diameter and depth, can be easily provided in in vivo tissue using laser drilling.

Mechanical compression and seeded cell adhesion needed for a tissue matrix and the production of other tissue components can be provided within ablated channels due to the intrinsic tension of dental tissue, and can be easily provided externally in any direction that will be needed.

Electrophoresis, sonophoresis, and magnetophoresis techniques may be valuable in in vivo tissue engineering of perforated tissues. In particular, magnetic tagging of stem cells delivery, cell guiding to sites of repair, and switching on/off their activation are under discussion now. In vitro transduction of magnetic particles into C12S cells encoding GFP in the presence of a magnetic field was shown.

Tooth tissue drilling provides a controllable way of making an incision in the enamel and he dentin. Stem cells may stimulate the processes of dentin rejuvenation, because it is believed that the reconstitution of the dentin is activated by local stem cells. Similarly, the reconstitution of the dental collagen and fibroblast population could happen by activating the distant bone marrow-derived cells (circulating in blood) and the pulpal mesenchymal cells. The laser produced tooth porosity may be considered as a prospective tool for exogenous stem cell implanting. Laser ablated microholes (incisions) in the dental alveolus and underlying tissue may serve as an excellent natural bioreactor, where tissue environment works as a natural biochemical infrastructure that, of course, if needed can be modified (modulated) by inserting accompanying biochemical ingredients via the same drilled holes. It is very important that in such natural bioreactors—besides biochemical environment—other requirements needed for proper cell division and modification, such as cell adhesion and tension, can be realized automatically.

Required parameters for efficient tissue engineering, such as porosity, a channels diameter and depth, can be easily provided in in vivo tissue using laser ablative technique.

Chemical stimulators, e.g. growth factor, agonist (a substance that binds to a specific receptor and triggers a response in the cell, it mimics the action of an endogenous ligand (such as hormone or neurotransmitter) that binds to the same receptor) are needed to provide controllable cell growing and tissue rejuvenation. Laser ablative technology may also be useful in the supplying of such chemical stimulators if needed.

Electrophoresis, sonophoresis, and magnetophoresis can be used in in vivo tissue engineering (repairing or rejuvenation) of laser drilled tooth tissue for stem cell tagging and delivery, cell guiding to sites of repair, and switching on/off their activation, in particular to be differentiated into other cells.

### Other Embodiments

While the invention has been described in conjunction with the detailed description thereof, the foregoing description is intended to illustrate and not to limit the scope of the invention, which is defined by the scope of the appended claims. Other aspects, advantages, and modifications are within the scope of the following claims. The use of “such as” and “for example” are only for the purposes of illustration and do not limit the nature or items within the classification.

1. A method of modifying, treating or diagnosing of biological tissue by microperforating hard tissue, the method comprising:
identifying a target area associated with the hard tissue;
using a laser beam to perforate at least one incision in the hard tissue, wherein at least one incision has a diameter from a range of 0.001 mm to 0.5 mm and an aspect ratio from a range of 1 to 100 times;
introducing a treatment substance into the incision; and
causing the treatment substance to interact with the target area.

2. The method of claim 1, wherein at least one incision has a diameter from a range of 0.001 mm to 0.3 mm and the aspect ratio ranges from 5 to 100 times.

3. (canceled)

4. The method of claim 1, wherein the laser beam has a wavelength selected from a range of 190 nm to 350 nm, or from a range of 2500 nm to 3000 nm, or from a range of 9000 nm to 11000 nm, a pulse duration selected from a range of 1 ps to 10 ms and an energy density selected from a range of 0.01 J/cm² to 500 J/cm²

5. (canceled)

6. The method of claim 1, wherein the treatment substance is a dental whitening composition.

7. (canceled)

8. The method of claim 1, wherein causing the treatment substance to interact with the target area comprises controlling diffusion of the treatment substance into the hard tissue.

9. The method of claim 8, wherein controlling the diffusion of the treatment substance is done by electrophoresis, magnetophoresis, phonophoresis and thermo-stimulated diffusion.

10. The method of claim 1 where the treatment substance is encapsulated.

11. (canceled)

12. (canceled)

13. (canceled)

14. (canceled)

15. (canceled)

16. (canceled)

17. (canceled)

18. (canceled)

19. The method of claim 1, wherein the treatment substance is used for caries prevention, pulp therapy, apical therapy, pain management, tooth regeneration, periodontal therapy, or endodontic therapy.

20. The method of claim 1 wherein the treatment substance is activated by light.

21. (canceled)

22. The method of claim 1, further comprising sealing at least one incision after introducing the treatment substance.

23. (canceled)

24. (canceled)

25. The method of claim 1, wherein the treatment substance has fluorescent effect.

26. The method of claim 1, further comprising cooling the hard tissue with a fluid during perforation.

27. A method of mounting a prosthesis on hard tissue comprising:
perforating at least one incision having a diameter from a range of 0.03 mm to 0.5 mm, a length from a range of 100 μm to 10000 μm and an aspect ratio from a range of 1 to 100 times;
introducing at least one mounting pin into at least one incision and fastening at least one mounting pin in the incision;
drilling at least one matching incision in the prosthesis or having at least one matching incision be made in advance; and
mounting the prosthesis on at least one mounting pin and fastening the prosthesis to the hard tissue.

28. The method of claim 27, wherein perforating at least one incision is done by a laser.

29. The method of claim 28, wherein the laser has a wavelength selected from a range of 190 nm to 350 nm, or from a range of 2500 nm to 3000 nm, or from a range of 9000 nm to 11000 nm, a pulse duration selected from a range of 1 ps to 10 ms and an energy density selected from a range of 0.01 J/cm² to 500 J/cm².

30. The method of claim 27, wherein the prosthesis is a dental veneer, dental crown, inlay, onlay, dental filling, and wherein the hard tissue is dental enamel or dentin.

31. A device for microperforating incisions with a diameter from a range of 0.001 mm to 0.5 mm and an aspect ratio from a range of 1 to 100 times hard biological tissue, comprising:
a laser pump system and a laser head coupled to the laser pump system for generating a pulsed laser having a wavelength selected from a range of 190 nm to 350 nm, or from a range of 2500 nm to 3000 nm, or from a range of 9000 nm to 11000 nm, a pulse duration from a range of 1 ps to 10 ms, a pulse energy less that than 100 mJ, a beam divergence factor of less than 5; and
a beam delivery system comprised of a focusing system for creating a beam having a diameter from a range of 0.001 mm to 0.5 mm and an energy density from a range from 0.01 J/cm² to 500 J/cm² on a surface of the hard tissue.

32. The device of claim 31, further comprising a scanning mechanism for guiding the beam across the hard tissue.

33. The device of claim 31, wherein the laser is a diode laser pumped solid state laser, a diode laser pumped fiber laser, or a diode laser, or a flash lamp pumped solid state laser.

34. The device of claim 31, further comprising a handpiece with a tip for positioning the beam delivery system against the surface of the hard tissue.

35. (canceled)

36. (canceled)

37. The device of claim 34, wherein the laser is initiated automatically when the handpiece contacts the hard tissue.

38. The device of claim 33, wherein the laser head is housed in the handpiece.

39. (canceled)

40. (canceled)

41. (canceled)

42. (canceled)

43. (canceled)

44. (canceled)

45. (canceled)

46. (canceled)

47. The method of claim 1, wherein the treatment substance comprises stem cells.

48. The method of claim 1, further comprising:
introducing a diagnostic contrast changing substance into at least one incision; and
causing the contrast changing substance to interact with the target area or the hard tissue by diffusing or dissolving into the hard tissue.

49. The method of claim 48, wherein changing the target area comprises altering its optical scattering, optical absorption, optical fluorescence, optical phosphorescense, acoustical impedance, X-ray scattering, X-ray absorption, or electrical impedance.

50. The device of claim 31, wherein the incision has a diameter from a range of 0.001 mm to 0.3 mm and the aspect ratio ranges from 5 to 100 times.
